(19) United States
(12) Patent Application Publication
(10) Pub. No.: US 2025/0341102 A1
(43) Pub. Date: Nov. 6, 2025

(54) FLOORING PANELS INCORPORATING SUSTAINABLE THERMOPLASTIC POLYURETHANE MATERIALS

(71) Applicant: HMTX INDUSTRIES, LLC, Norwalk, CT (US)

(72) Inventors: Bram VANROY, Haasrode (BE); Hugo VERBEKE, Wilsele Wilsele (BE); Stef PEETERS, Everberg (BE); David BRIERS, Brussels (BE); Erika VANEMPTEN, Nieuwerkerken (BE); Hanson WAN, Jinshanwei, Shanghai (CN)

(21) Appl. No.: 18/870,770

(22) PCT Filed: May 25, 2023
(86) PCT No.: PCT/US2023/067463

§ 371 Date: Dec. 2, 2024

Related U.S. Application Data
(60) Provisional application No. 63/365,623, filed on Jun. 1, 2022.

(51) Int. Cl. E04F 15/10; B32B 27/08; B32B 27/40; C08G 18/42; C08G 18/76; C08J 9/36

(52) U.S. Cl. CPC E04F 15/107; B32B 27/08; B32B 27/40; C08G 18/4213; C08G 18/7671; C08J 9/36; B32B 2250/24; B32B 2274/00; B32B 2307/4023; B32B 2471/00; C08G 2110/0075; C08J 2201/022; C08J 2201/03; C08J 2375/06

(57) ABSTRACT

An exemplary embodiment provides a flooring panel, comprising a core layer comprising a thermoplastic polyurethane (TPU) having a shore D hardness in the range 50-100 and a glass transition temperature above room temperature. The TPU can be formed from a reactive formulation, comprising an isocyanate composition, an isocyanate-reactive composition, optionally a catalyst compound, and optionally additives and/or fillers. The isocyanate composition can comprise at least one difunctional isocyanate compound. The isocyanate-reactive composition can comprise at least one aromatic dicarboxylic acid based diol chain extender having a molecular weight <500 g/mol. The hardblock content of the reactive formulation can be >70 wt % based on the total weight of the isocyanate and isocyanate-reactive composition, the isocyanate index can be in the range 75 up to 125, and the number average isocyanate functionality and/or the number average hydroxy functionality can be in the range of 1.8 up to 2.5.

### CROSS-REFERENCE TO RELATED APPLICATIONS

This application claims the benefit of U.S. Provisional Application Ser. No. 63/365,623, filed on 1 Jun. 2022, which is incorporated herein by reference in its entirety as if fully set forth below.

### FIELD OF THE DISCLOSURE

The various embodiments of the present disclosure relate generally to floor, ceiling, and wall covering products, and more particularly to floor and wall covering products incorporating thermoplastic polyurethane materials having high hardness, high flexural modulus, and glass transition temperatures above room temperature.

### BACKGROUND

Engineered building panels and tiles are commonly used in businesses, homes, and institutions and offer many benefits ranging from enhanced floor protection, comfort, design versatility, low maintenance and, in some cases, easy installation. Additionally, engineered building panels can replace wood and plywood, providing environmental benefits, namely by reducing deforestation.

Engineered panels and tiles are typically composed of several layers. The outer layer, or image layer, having a high-resolution decorative image of wood, tile, or stone is often sealed under a protective resin-based coating. The core layer, where the majority of the density of the entire panel resides, provides structure. A backing layer holds the engineered panel together. Some engineered panels and tiles also include an attached underlayment layer for easier installation. The panels and tiles can be laid on a surface and mechanically coupled together to form floor coverings and wall or ceiling sheathing without the use of an adhesive, thereby reducing the labor and time of the installing phase. Such a kind of floor covering is known as a floating floor covering.

In recent years, manufacturers have developed panels and tiles with polymeric rigid cores made of vinyl-based polymers mixed with additives such as wood-plastic composite (WPC) or stone polymer composite (SPC). The composition of the core impacts properties such as rigidity or stiffness, thickness, water resistance, thermal insulation, acoustic insulation, density, and durability of the entire panel. One of the shortcomings of vinyl-based floor or wall panels is a tendency to curling. Curling is the result of expansion and shrinking of the layers within floor or wall panels upon changing temperatures. Different degrees of shrinking and/or expansion of the vinyl-based floor or wall panels results either a positive curling or negative curling, and non-flat floor or wall panels. Curling of adjacent floor or wall panels can lead to damage such as, for example, panels decoupling, joints becoming stressed, and/or delamination of the surface.

These vinyl panels present many environmental drawbacks due to the chlorine and heavy-metals from plasticizers and stabilizers that can be carcinogenic or toxic. In addition, vinyl products must be treated properly prior to recycling or melting for reuse in new panels to avoid releasing hydrochloric acid during burning or releasing heavy metals into the environment. Because of the environmental drawbacks associated with vinyl products, some panels can employ polyurethane based materials that can provide a more sustainable product. Polyurethanes can be made from recycled or reusable materials. The environmental benefit of starting from recycled or reusable materials, such as recycled carpet fibers or plastic bottles, can help reduce plastic waste entering landfills or the world's water bodies while producing a sustainable and resilient alternative to conventional vinyl-based panels.

But conventional polyurethane materials have properties making them difficult to implement large scale manufacturing of polyurethane-based panels. For example, current state of the art thermoplastic polyurethane (TPU) materials with high hardness and high flexural modulus have a narrow processing window are TPU materials with a high content of low molecular weight compounds (high hardblock content) leading to processing temperatures which are often very close to the degradation temperature of the thermoplastic polyurethane materials due to the high crystallinity and/or hydrogen bond density of these TPU materials.

One of the materials that solves the issue of narrow processing window are the Isoplast® materials, such as reference material Isoplast®301 (High hardblock TPU from Lubrizol) as described in U.S. Pat. Nos. 5,167,899 and 5,574,092, each of which are incorporated herein by reference in its entirety as if fully set forth below. In U.S. Pat. No. 5,574,092, the mechanism behind it is explained, which is the depolymerization at the processing temperature using an aromatic diol (the term aromatic diol used U.S. Pat. No. 5,574,092 specifically describe an aromatic or heteroaromatic moiety having two OH groups attached directly to the aromatic carbon atoms, resulting in a thermally reversible urethane bond when reacted with an isocyanate). A rigid, extrudable polyurethane material is disclosed having a specific amount of hard segments which have excellent microfiber-forming properties such as low viscosity, high melt strength and good melt elasticity when depolymerized at melt temperatures. The depolymerized polyurethane can be readily repolymerized to provide rigid polyurethane having sufficient molecular weight and desired physical and chemical properties such as toughness, chemical resistance and dimensional stability. A disadvantage of this “high degree of depolymerization” is that the polyurethane needs to be carefully processed and extremely well dried to avoid side reactions (water+isocyanate=>CO₂ formation) that cause bubbles in the processed parts (bubbles are weak spots in the final part). The extreme drying of the polymer (TPU), but also additives (e.g. plasticizers) and/or fillers (such as fibers or powders) using the depolymerization approach (as described by U.S. Pat. No. 5,574,092) results in undesired additional costs and energy consumption.

A drawback of using 90-100 wt % hardblock materials (made using conventional chain extenders as iso-reactive compounds) without a “depolymerization mechanism” as described in U.S. Pat. No. 5,574,092, is that they all show relatively high melting points, especially for monoethelyneglycol (MEG) and butanediol (BDO). This means that the material can only be thermoplastically processed above the melting temperature (>220-230° C.). Very often the degradation temperature of these TPU's is close to or below the melting temperature. This results in degradation of the polymer during thermal processing (especially if long exposure to temperature is required). The processing of these types of TPU's is often limited to solvent casting to avoid high temperature exposure. Solvent casting introduces not only environmental, health and safety risks (depending on the type of solvents) but also an additional energy consumption to evaporate the solvent.

In more standard high hardness TPU, a sufficient amount of high molecular weight polyols is used in combination with low molecular weight isocyanates and low molecular weight diols (chain extenders) for the preparation of TPU materials with a hardblock <70 wt %. These high molecular weight polyols are often thermally more stable (by itself) than the low molecular weight hardblock phase thereby resulting in a higher overall thermal stability of the TPU material. The flexural modulus of these materials however remains low, making them unsuitable for a number of applications. Additionally, the use of high molecular weight polyols often results in TPU's with a glass transition temperature below room temperature that exhibits undesirable changes in the flexural modulus at lower temperature (cold hardening). In the specific case where the used high molecular weight polyols are polyesters, the high level of ester bonds make the material more susceptible to hydrolytic degradation.

Furthermore, the industry is forced to use less petroleum-based resources and stimulate the use of recycled resources and/or produce materials which are recyclable. More in particular, for thermoplastic polyurethane (TPU) materials this could imply that the starting materials to make these thermoplastic polyurethane (TPU) materials are made from recycled materials and/or the thermoplastic polyurethane (TPU) materials itself are at least thermally recyclable without significant degradation during processing.

To solve the above problems, there is a need to produce thermoplastic polyurethane (TPU) materials with high hardness and high flexural modulus which have good thermal stability and have high degradation temperatures. Ideally these thermoplastic polyurethane (TPU) materials are also thermally recyclable without significant loss in properties and are processable at temperatures below 250° C. These TPU materials can then be incorporated into one or more layers of floor, wall, or ceiling panels to provide sustainable products that can be manufactured at large scales.

### BRIEF SUMMARY

The present disclosure provides flooring panels made at least in part from thermoplastic polyurethane (TPU) materials with high hardness (>50 Shore D, DIN ISO 7619-2) and high flexural modulus (>300 MPa, measured according to ISO 178) at room temperature, which have good thermal stability and have high degradation temperatures (temperature of 5 wt % loss measured according to ISO 11358-1 under Air condition) which is >250° C.

The present disclosure also provides flooring panels made at least in part from thermoplastic polyurethane (TPU) materials which are processable at temperatures below 250° C. while at the same time provide a material having a glass transition temperature (Tg) above room temperature, preferably a Tg above 40° C., more preferably a Tg above 55° C.

The present disclosure also provides flooring panels made at least in part from thermoplastic polyurethane (TPU) materials which are thermally recyclable and/or melt reprocessable after its service-life with minimal degradation (as can be expected from the good thermal stability).

The present disclosure also provides reactive formulations suitable for making the thermoplastic polyurethane (TPU) materials disclosed herein for use in flooring panels.

An exemplary embodiment of the present disclosure provides a flooring panel, comprising a core layer. The core layer can be comprised of thermoplastic polyurethane (TPU) having a shore D hardness (measured according to DIN ISO 7619-2) in the range 50-100 and a glass transition temperature (Tg, measured according to ISO 11357-2:2020) above room temperature. The TPU can be formed from a reactive formulation, comprising an isocyanate composition, an isocyanate-reactive composition, optionally a catalyst compound, and optional additives and/or filler. The isocyanate composition can comprise at least one difunctional isocyanate compound. The isocyanate-reactive composition can comprise isocyanate-reactive compounds selected from at least one aromatic dicarboxylic acid based diol chain extender having a molecular weight <500 g/mol. The hardblock content of the reactive formulation can be >70 wt % based on the total weight of the isocyanate and isocyanate-reactive composition. The isocyanate index can be in the range 75 up to 125. The number average isocyanate functionality and/or the number average hydroxy functionality can be in the range of 1.8 up to 2.5. The flooring panel can optionally comprise a top layer above a top surface of the core and/or optionally a bottom layer below a bottom side of the core.

In any of the embodiments disclosed herein, the isocyanate-reactive composition can have an hydroxy functionality in the range 1.8 up to 2.4 and can comprise at least 10 wt % of, at least 20 wt %, at least 30 wt %, at least 40 wt %, at least 50 wt %, at least 60 wt %, at least 70 wt %, at least 80 wt %, or at least 90 wt % of aromatic carboxylic acid based diol chain extenders having a molecular weight <500 g/mol calculated on the total weight of all chain extenders in the isocyanate reactive composition.

In any of the embodiments disclosed herein, the TPU can have a Tg (measured according to ISO 11357-2:2020)>35° C., a Tg>40° C., a Tg>45° C., a Tg>50° C., a Tg>55° C., or a Tg>70° C.

In any of the embodiments disclosed herein, the isocyanate reactive composition can comprise aromatic and aliphatic based diols such that at least 20 wt % of the diols, >30 wt %, >40 wt %, >50 wt %, >60 wt %, >70 wt %, or >75 wt % of the diols are selected from aromatic dicarboxylic acid based diols based on the total weight of the isocyanate reactive composition.

In any of the embodiments disclosed herein, the aromatic dicarboxylic acid based diol chain extender can be based on phthalic acid selected from o-phthalic acid, m-phthalic acid and/or p-phthalic acid), the aromatic diol chain extender can be based on p-phthalic acid (terephthalic acid), or the aromatic diol chain extender can be a terephthalic acid based polyester diol chain extender.

In any of the embodiments disclosed herein, the aromatic dicarboxylic acid based diol chain extender can be a terephthalic acid based polyester diol chain extender made from recycled PET.

In any of the embodiments disclosed herein, the hardblock content of the reactive formulation can be >70 wt %, >75 wt %, >80 wt %, >85 wt %, or 90-100 wt %.

In any of the embodiments disclosed herein, the number average functionality of isocyanate reactive compounds and/or isocyanate compounds and/or the complete reactive formulation (including all isocyanate and isocyanate reactive compounds) can be in the range of 1.8 up to 2.5, in the range of 1.9-2.2, in the range of 1.95-2.05, in the range of 1.95-2.02, in the range of 1.95-2.015, in the range of 1.95-2.012, in the range of 1.98-2.01, or in the range of 1.98-2.005.

In any of the embodiments disclosed herein, the isocyanate composition can have an NCO value in the range 3 up to 50, in the range 5 up to 33.6, in the range 10 up to 33.6, in the range 15 up to 33.6, in the range 20 up to 33.6, in the range 25 up to 33.6, or in the range 30 up to 33.6.

In any of the embodiments disclosed herein, the isocyanate compounds in the isocyanate composition can be selected from aromatic isocyanate compounds. The isocyanate composition can contain at least 80 wt %, at least 85 wt %, at least 90 wt %, at least 95 wt %, or at least 98 wt % 4,4′-diphenylmethane diisocyanates calculated on the total weight of the isocyanate composition.

In any of the embodiments disclosed herein, the isocyanate index of the reactive foam formulation can be in the range 75 up to 125, in the range 80 up to 120, in the range 85 up to 120, in the range 88 up to 120, in the range 90 up to 120, in the range 90 up to 110, in the range 92 up to 110, in the range 95 up to 110, in the range 95 up to 105, in the range 95 up to 102, or in the range 95 up to 100.

In any of the embodiments disclosed herein, the aromatic dicarboxylic acid based diol chain extender can have a molecular weight in the range 45 g/mol up to 500 g/mol, in the range 150 g/mol up to 500 g/mol, or in the range 250 g/mol up to 500 g/mol.

Another embodiment of the present disclosure provides a process for making a flooring panel. The panel can have a core comprising a thermally recyclable TPU. The method can comprise combining and reacting the compounds of the reactive formulation according to any of the embodiments disclosed herein to form the TPU and forming the TPU into the core of the flooring panel.

In any of the embodiments disclosed herein, forming the TPU into the core can comprise extruding the TPU.

In any of the embodiments disclosed herein, the method can further comprise attaching an underlayment pad to a bottom side of the core.

In any of the embodiments disclosed herein, the underlayment can comprise a TPU.

In any of the embodiments disclosed herein, the method can further comprise providing a protective layer above a top surface of the core.

In any of the embodiments disclosed herein, the protective layer can comprise a TPU.

In any of the embodiments disclosed herein, the method can further comprise providing a decorative print layer to a top surface of the core.

In any of the embodiments disclosed herein, the method can further comprise printing a decorative pattern on a top surface of the core.

Another embodiment of the present disclosure provides a flooring panel having a core. The core can comprise a thermoplastic polyurethane (TPU) material having a glass transition temperature (Tg) greater than room temperature, greater than 40° C., or greater than 55° C. The TPU material can have a flexural modulus in the range 300-15000 MPa (measured according to ISO 178), or in the range 1500-2700 MPa. The TPU material can have a tensile strength at break (according to DIN 53504) in the range of 5 up to 150 MPa. The TPU material can be made by combining and reacting the compounds of the reactive formulation according to any of embodiments disclosed herein.

In any of the embodiments disclosed herein, the flooring panels can be made using a reactive formulation wherein the aromatic dicarboxylic acid based diol chain extender can be a terephthalic acid based polyester diol chain extender made from recycled PET. The TPU material can contain a recycled content of ≥2 w %, ≥5 w %, ≥10 w %, ≥15 w %, ≥20 w %, or ≥25 w % based on the total weight of the TPU material (excluding any fillers).

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1 provides a flooring panel, in accordance with an exemplary embodiment of the present disclosure.

### DEFINITIONS AND TERMS

In the context of the present disclosure, the following terms have the following meaning.

“NCO value” or “isocyanate value” as referred to herein is the weight percentage of reactive isocyanate (NCO) groups in an isocyanate, modified isocyanate, or isocyanate prepolymer compound.

The expression “isocyanate-reactive hydrogen atoms” as used herein for the purpose of calculating the isocyanate index refers to the total of active hydrogen atoms in hydroxyl and amine groups present in the reactive compositions; this means that for the purpose of calculating the isocyanate index at the actual polymerization process one hydroxyl group is considered to comprise one reactive hydrogen, one primary amine group is considered to comprise one reactive hydrogen and one water molecule is considered to comprise two active hydrogens.

The “isocyanate index” or “NCO index” or “index” as referred to herein is the ratio of available NCO-equivalents in the reactive mixture to the sum of available equivalents of isocyanate-reactive hydrogen atoms present in the reactive mixture, given as a percentage:

$$\frac{[ NCO ] \times 100}{[ active hydrogen ]} ( \% )$$

In other words, the NCO-index expresses the percentage of isocyanate actually used in a formulation (reactive mixture) with respect to the amount of isocyanate theoretically required for reacting with the amount of isocyanate-reactive hydrogen used in a formulation (reactive mixture). In the specific case where an isocyanate prepolymer is used in the reactive mixture, it is clear that a part of the NCO-equivalents and equivalents of isocyanate-reactive hydrogen atoms is no longer available to participate in the reaction. These “consumed” equivalents used in the making of the isocyanate prepolymer should thus not be considered in the calculation of the isocyanate index.

The term “average nominal functionality of a compound” (or in short “functionality”) is used herein to indicate the number average of functional groups per molecule in a composition. It reflects the real and practically/analytically determinable number average functionality of a chemical structure. In case of the “average nominal hydroxyl functionality” (or in short “hydroxyl functionality”) it is used to indicate the number average hydroxyl functionality (number of hydroxyl groups per molecule) of the polyol or polyol composition on the assumption that it is the real and practically/analytically determinable number average functionality. This functionality is in some cases is lower than the theoretically determined functionality (number of active hydrogen atoms per molecule) of the initiator(s) sometimes used in their preparation.

The term “average nominal functionality of a composition” (or in short “functionality of a composition”) is used herein to indicate the number average of functional groups per molecule in a composition. It reflects the real and practically/analytically determinable number average functionality of a composition. In case of a blend of materials (isocyanate blend, polyol blend, reactive mixture) the “average nominal functionality” of the blend is identical to the “molecular number average functionality” calculated via the total number of molecules of the blend in the denominator. It thereby requires using the real and practically/analytically determinable number average functionality of each of the chemical compounds of the blend. In case of a reactive foam formulation the molecular number average functionality of the complete reactive composition should be taken into account (thus including all isocyanate and isocyanate reactive compounds).

The term “hardblock” refers to 100 times the ratio of the amount (in pbw) of polyisocyanate+isocyanate-reactive compounds having a molecular weight less than 500 g/mol (wherein isocyanate-reactive compounds having a molecular weight of more than 500 g/mol incorporated in the polyisocyanates are not taken into account) over the amount (in pbw) of all polyisocyanate+all isocyanate-reactive compounds used. The hardblock content is expressed in wt %.

The word “average” refers to number average unless indicated otherwise.

As used herein, the term “thermoplastic” is used in its broad sense to designate a material that is reprocessable at an elevated temperature, whereas “thermoset” designates a material that exhibits high temperature stability but without such reprocessability at elevated temperatures. Thermoset materials typically degrade before melting giving them almost no reprocessability at melting temperature.

The term “difunctional” as used herein means that the average nominal functionality is about 2. A difunctional polyol (also referred to as a diol) refers to a polyol having an average nominal hydroxyl functionality of about 2 (including values in the range 1.9 up to 2.1). A difunctional isocyanate refers to an isocyanate composition having an average nominal isocyanate functionality of about 2 (including values in the range 1.9 up to 2.1).

The term “polyurethane,” as used herein, is not limited to those polymers which include only urethane or polyurethane linkages. It is well understood by those of ordinary skill in the art of preparing polyurethanes that the polyurethane polymers may also include allophanate, carbodiimide, uretidinedione, and other linkages in addition to urethane linkages.

The expressions “Reaction system,” “Reactive formulation,” and “Reactive mixture” are interchangeably used herein and all refer to a combination of reactive compounds used to make the thermoplastic material according to the disclosure wherein the polyisocyanate compounds are usually kept in one or more containers separate from the isocyanate-reactive compounds before reaction.

The term “room temperature” refers to temperatures of about 20° C., this means referring to temperatures in the range 18° C. to 25° C. Such temperatures will include, 18° C., 19° C., 20° C., 21° C., 22° C., 23° C., 24° C. and 25° C.

Unless otherwise expressed, the “weight percentage” (indicated as % wt or wt %) of a component in a composition refers to the weight of the component over the total weight of the composition in which it is present and is expressed as percentage.

Unless otherwise expressed, “parts by weight” (pbw) of a component in a composition refers to the weight of the component over the total weight of the composition in which it is present and is expressed as pbw.

Unless otherwise specified, “Shore A hardness” and “Shore D hardness” refer to the material hardness, respectively, measured according to DIN ISO 7619-1 and DIN ISO 7619-2.

“Storage modulus” is measured using dynamic mechanical thermal analysis (DMTA) according to ISO 6721 using a dual cantilever (flexural mode). It is mostly used to investigate the flexural behavior of the TPU materials disclosed herein in function of temperature (or in function of time at a certain temperature). The method is performed using a heating/cooling rate of 3° C./min at a frequency of 1 Hz and amplitude of 10 μm. The storage modulus is expressed in MPa.

“Flexural modulus” or “bending modulus” is measured according to ISO 178 and is used to investigate the flexural behavior of the TPU materials disclosed herein and is performing using a three-point bend test using a 65 mm support span. The flexural modulus is expressed in MPa.

“Flexural strength at max load” and “Flexural strain at max load” as referred to herein is measured according to ISO 178 using a support span of 65 mm and is expressed respectively in MPa and %. These properties describe the maximum load and strain which a sample can withstand in a three-point bending test before it yields or breaks.

“Tensile strength” and “elongation” as referred to herein are measured according to DIN 53504 and is respectively expressed in MPa and %. The test is performed using a S1 specimen type and a test speed of 100 mm/min. The Tensile strength is expressed in MPa while the elongation is expressed as a %.

“Glass transition temperature” and “Tg” as referred to herein refers to the temperature at which a reversible transition from a hard glass condition into a rubber-elastic condition occurs and is measured according to ISO 11357-2:2020 using differential scanning calorimetry at a heating rate of 10 K/min and analyzing the 2^{nd} heating cycle.

“Melt Volume Rate” and “MVR” is the rate of extrusion of a molten resin through a capillary of specified length and diameter under prescribed conditions of temperature and pressure, the rate being determined as the volume extruded over a specified time. MVR is expressed in units of cubic centimetres per 10 min (cm3/10 min) and is measured according to ISO 1133 using 5 minutes preheat time. The temperature and load mass (e.g. 8.7 kg) used during the measurement should be specified for each sample.

“Melting temperature,” “Melting temperature range,” “Melting point,” and “Tm” as referred to herein are measured using the Melt Volume Rate since most materials according to the disclosure are (partially) amorphous. Often the melting temperature is a range of temperatures due to the gradual softening and flowing of the material. It can thus not be (easily) determined using differential scanning calorimetry (ISO 11357-2:2020). Alternatively, the Melting temperature of the materials according to the disclosure are determined as the temperature at which the MVR (according to ISO 1133 using 5 minutes of preheat time) is ≥1 cm3/10 min when a load mass of 8.7 kg is used.

The term “difunctional polyol” refers to a polyol having an average hydroxyl functionality of about 2, preferably in the range 1.9-2.1. A difunctional polyol (diol) composition according to the present disclosure does not have an average hydroxyl functionality of more than 2.2 and does not have an average hydroxyl functionality of less than 1.8.

“High Molecular weight isocyanate reactive compounds” and “high MW isocyanate reactive compounds” refer herein to isocyanate reactive compounds having a molecular weight >500 g/mol having isocyanate reactive functional group(s) and a functionality in the range 1.8 up to 2.5. Examples are polyols, amines, or other isocyanate reactive compounds with a molecular weight >500 g/mol. These compounds have at least 1 isocyanate reactive hydrogen atom.

“Low Molecular weight isocyanate reactive compounds” and “low MW isocyanate reactive compounds” refer herein to isocyanate reactive compounds having a molecular weight <500 g/mol having isocyanate reactive functional group(s) and a functionality in the range 1.8 up to 2.5. Examples are polyols, amines or other isocyanate reactive compounds with a molecular weight <500 g/mol These compounds have at least 1 isocyanate reactive hydrogen atom. The hydroxyl value and average nominal functionality can be used to calculate the number average molecular weight of certain blends of isocyanate reactive compounds.

“Reactive extrusion” refers to a manufacturing method that combines the traditionally separated chemical processes (polymer synthesis and/or modification) and extrusion (melting, blending, structuring, devolatilization and shaping) into a single process carried out onto an extruder. Typically, two or more liquid compositions are fed into the extruder where the material polymerizes while it is kept in the melt phase.

“Dicarboxylic acids” correspond to organic compounds containing two carboxyl functional groups (—COOH). The general molecular formula for dicarboxylic acids can be written as HOOC—R—COOH, where R can be aliphatic or aromatic. The most important aromatic dicarboxylic acids are phthalic, isophthalic, and terephthalic acid (for the ortho, meta, and para isomers). Terephthalic acid is used in the manufacture of the polyester known by brand names such as PET.

“Dicarboxylic acid based diols” refers to reaction products of dicarboxylic acids and other chemicals to form diols. Typically, the dicarboxylic acids are combined with glycols to form dicarboxylic acid based diols. When the dicarboxylic acid is an aromatic dicarboxylic acid, an aromatic dicarboxylic acid based diol is formed. Recycled terephthalic acid from PET can be used in the current disclosure as a source for aromatic dicarboxylic acid based diols. In practice these aromatic dicarboxylic acid based diols can be both very pure products or a complex mixture of diols. In case a complex mixture of diols is made during the preparation of the aromatic dicarboxylic acid based diols, the hydroxyl value and average nominal functionality of the mixture can be used to calculate the number average molecular weight.

### DETAILED DESCRIPTION

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

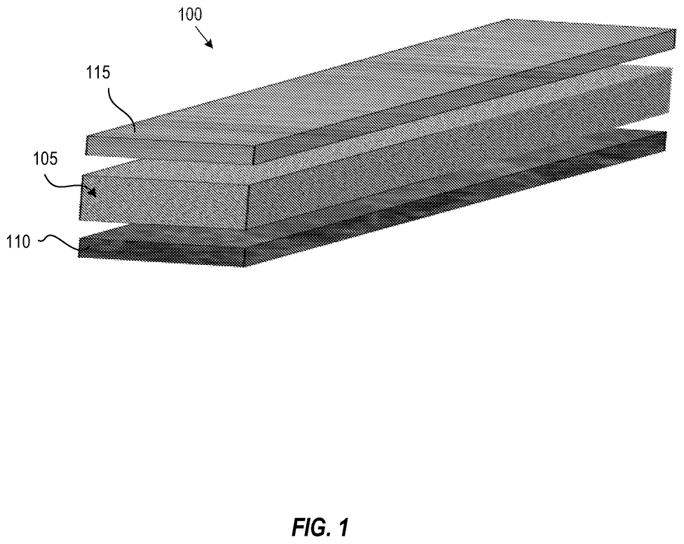

Various embodiments of the present disclosure provide flooring panels/planks and/or wall panels/coverings and methods of making the same. The flooring panels disclosed herein can have one or more layers. FIG. 1 illustrates a multi-layer flooring panel 100 in accordance with some embodiments of the present disclosure. The flooring panels disclosed herein can comprise core 105, underlayment 110 positioned beneath the core, and protective layer 115 positioned above the core. The panel 100 can further comprise a decorative pattern. In some embodiments, the decorative pattern can be printed on a film layer and positioned between the protective layer 115 and the core 105. In some embodiments, the decorative pattern can be printed directly on the core 105.

One or more of each of the underlayment 110, core 105, and protective layer can comprise a polyurethane material. In some embodiments, the polyurethane materials can be thermoplastic polyurethane materials.

Accordingly, the present disclosure provides thermoplastic polyurethane (TPU) materials for use in flooring panels, which have a glass transition temperature (Tg) above room temperature and have surprisingly good mechanical properties such as a high flexural modulus (>300 MPa, measured according to ISO 178) at room temperature and high hardness (>50 Shore D, DIN ISO 7619-2). Further the TPU materials according to the disclosure can be processable at temperatures below 250° C. and easily melt-reprocessable and recyclable after use.

The present disclosure also provides methods and reactive mixtures for making the TPU materials for use in flooring panels and/or wall panels.

The characteristics of the TPU material can be achieved by using a reactive formulation having a hardblock content of at least 70 wt % and an isocyanate-reactive composition comprising at least an aromatic dicarboxylic acid based diol chain extender having a molecular weight <500 g/mol.

Therefore, the present disclosure provides a reactive formulation for forming a thermoplastic polyurethane (TPU) for use in a flooring panel, wherein the TPU can have a shore D hardness (measured according to DIN ISO 7619-2) in the range 50-100 Shore D and a glass transition temperature (Tg)>room temperature, said reactive formulation comprising:
an isocyanate composition comprising at least one difunctional isocyanate compound;
an isocyanate-reactive composition comprising isocyanate-reactive compounds selected from at least one aromatic dicarboxylic acid based diol chain extender having a molecular weight <500 g/mol;
optionally a catalyst compound; and
optionally further additives and/or fillers;
wherein the hardblock content of the reactive formulation can be >70 wt % based on the total weight of the isocyanate and isocyanate-reactive composition, the isocyanate index can be in the range 75 up to 125 and the number average isocyanate functionality and/or the number average hydroxy functionality can be in the range of 1.8 up to 2.5.

According to some embodiments, the weight % (wt %) hardblock of the reactive formulation can be >70 wt %, more preferably >75 wt %, preferably >80 wt %, more preferably >85 wt %, and most preferably 90-100 wt %.

According to some embodiments, the isocyanate index of the reactive foam formulation can be in the range 75 up to 125, in the range 80 up to 120, in the range 85 up to 120, in the range 88 up to 120, in the range 90 up to 120, in the range 90 up to 110, in the range 92 up to 110, in the range 95 up to 110, in the range 95 up to 105, in the range 95 up to 102, in the range 95 up to 100.

According to some embodiments, the number average overall functionality (hydroxy and NCO functionality) of the reactive formulation (taking into account all isocyanate compounds and isocyanate reactive compounds) can be in the range of 1.8 up to 2.2, more preferably in the range of 1.9-2.1, more preferably in the range of 1.95-2.05, more preferably in the range of 1.95-2.02, more preferably in the range of 1.95-2.015, more preferably in the range of 1.95-2.012, even more preferably in the range of 1.98-2.01, and most preferably in the range of 1.98-2.005, which can make the TPU thermally recyclable.

According to some embodiments, the number average functionality of isocyanate reactive compounds and/or isocyanate compounds and/or the complete reactive formulation (including all isocyanate and isocyanate reactive compounds) can be in the range of 1.8 up to 2.5, more preferably in the range of 1.9-2.2, more preferably in the range of 1.95-2.05, more preferably in the range of 1.95-2.02, more preferably in the range of 1.95-2.015, more preferably in the range of 1.95-2.012, even more preferably in the range of 1.98-2.01, and most preferably in the range of 1.98-2.005.

### The Isocyanate Reactive Composition

According to some embodiments, the isocyanate-reactive composition can have a number average hydroxy functionality in the range 1.8 up to 2.4 and can comprise at least 10 wt % of aromatic carboxylic acid based diol chain extenders having a molecular weight <500 g/mol based on the total weight of all chain extenders in the isocyanate reactive composition.

According to some embodiments, the isocyanate reactive composition can comprise at least 10 wt %, more preferably at least 20 wt %, more preferably at least 40 wt %, more preferably at least 50 wt %, more preferably at least 60 wt %, more preferably at least 70 wt %, more preferably at least 80 wt % aromatic dicarboxylic acid based diols having a molecular weight ≤500 g/mol based on the total weight of all chain extenders in the isocyanate reactive composition.

According to some embodiments, the aromatic dicarboxylic acid based diol chain extender can have a number average molecular weight (as calculated from the functionality and hydroxyl value, OH value) in the range 45 g/mol up to 500 g/mol, more preferably in the range 150 g/mol up to 500 g/mol, most preferably in the range 250 g/mol up to 500 g/mol.

According to some embodiments, the aromatic dicarboxylic acid based diol chain extender can have a hydroxyl value (OH value) in the range of 224 up to 1000 mg KOH/g, more preferably in the range of 224 up to 750 mg KOH, more preferably in the range of 224 up to 600 mg KOH, more preferably in the range of 224 up to 500 mg KOH, most preferably in the range of 224 up to 280 mg KOH.

According to some embodiments, the aromatic dicarboxylic acid based diol chain extender can be based on phthalic acid selected from o-phthalic acid, m-phthalic acid (also referred to as isophthalic acid) and/or p-phthalic acid (also referred to as terephthalic acid), more preferably the aromatic diol chain extender can be based on terephthalic acid, most preferably the aromatic diol chain extender can be a terephthalic acid based polyester diol chain extender.

According to some embodiments, the aromatic dicarboxylic acid based diol chain extender can be made using at least 1 type of glycol. More preferably the aromatic dicarboxylic acid based diol chain extender can be made using at least 2 types of glycols. Most preferably the aromatic dicarboxylic acid based diol chain extender can be made using at least 3 types of glycols.

According to some embodiments, the aromatic dicarboxylic acid based diol chain extender can be a terephthalic acid based polyester diol chain extender made from recycled PET.

According to some embodiments, the isocyanate reactive composition may comprise aromatic and aliphatic based diols such that at least 20 wt % of the diols, preferably >30 wt %, preferably >40 wt %, preferably >50 wt %, preferably >60 wt %, preferably >70 wt %, more preferably >75 wt % of the diols are selected from aromatic dicarboxylic acid based diols based on the total weight of the isocyanate reactive.

According to some embodiments, the isocyanate reactive composition comprises ≤50 wt % high molecular weight polyols having a molecular weight >500 g/mol, more preferably ≤40 wt % high molecular weight polyols having a molecular weight >500 g/mol, more preferably ≤30 wt % high molecular weight polyols having a molecular weight >500 g/mol, more preferably ≤20 wt % high molecular weight polyols having a molecular weight >500 g/mol, more preferably ≤10 wt % high molecular weight polyols having a molecular weight >500 g/mol, most preferably the isocyanate reactive composition contains no high molecular weight polyols.

According to some embodiments, the isocyanate reactive composition can comprise at least 50 wt % low molecular weight polyols having a number average molecular weight ≤500 g/mol, preferably at least 60 wt % low molecular weight polyols, preferably at least 70 wt % low molecular weight polyols, preferably at least 80 wt % low molecular weight polyols, preferably at least 85 wt % low molecular weight polyols, preferably at least 90 wt % low molecular weight polyols, preferably at least 95 wt % low molecular weight polyols. Most preferably the isocyanate reactive composition contains only low molecular weight diols ≤500 g/mol.

According to some embodiments, the isocyanate reactive compounds in the reactive formulation can comprise mainly low MW isocyanate reactive compounds which are selected from at least 75% by weight difunctional polyols, more preferably at least 85% by weight difunctional polyols, most preferably at least 90% by weight difunctional polyols calculated on the total weight of all isocyanate reactive compounds in the reactive formulation.

According to some embodiments, the TPU material can be fabricated using an isocyanate reactive composition which comprises mainly low molecular weight diols selected from aromatic dicarboxylic acid based diol.

According to some embodiments, the TPU material can be fabricated using an isocyanate reactive composition which comprises mainly low molecular weight difunctional polyol(s) selected from aromatic dicarboxylic acid based diol and aliphatic and/or cycloaliphatic based diols.

According to some embodiments, the TPU material can contain a recycled content of ≥2 wt %, more preferably of ≥5 wt %, more preferably of ≥10 wt %, more preferably of ≥15 wt %, more preferably of ≥20 wt %, most preferably of ≥25 wt %.

According to some embodiments, the low MW aliphatic based diols can have a molecular weight <500 g/mol, preferably a molecular weight in the range 45 g/mol up to 500 g/mol, more preferably in the range 50 g/mol up to 250 g/mol and can be selected from 1,6-hexanediol, 1,4-butanediol, monoethylene glycol, diethylene glycol, triethyleneglycol, tetraethyleneglycol, propylene glycol, dipropylene glycol, tripropylene glycol, 1,3-propanediol, 1,-3-butanediol, 1,5-pentanediol, Polycaprolactone diol, 2-methyl-1,3-propanediol, neopentyl glycol, 1,4-cyclohexanedimethanol, hydroquinone bis (2-hydroxyethyl) ether (HQEE), 1,3-Bis (2-hydroxyethyl) resorcinol (HER), ethanolamine, methyldiethanolamine and/or phenyldiethanolamine and/or combinations of two or more of these chemicals. Preferably the low MW aliphatic based diols can be selected from 1,6 hexanediol, 1,4-butanediol, diethyleneglycol, 1,4-cyclohexanediol, monoethylene glycol or combinations of two or more of these chemicals.

According to some embodiments, the low MW aliphatic diols can have a molecular weight in the range 45 g/mol up to 500 g/mol, more preferably in the range 45 g/mol up to 400 g/mol, more preferably in the range 45 g/mol up to 300 g/mol, more preferably in the range 45 g/mol up to 250 g/mol, more preferably in the range 60 g/mol up to 200 g/mol, most preferably in the range 90 g/mol up to 150 g/mol.

According to some embodiments, the isocyanate reactive composition may optionally comprise a low amount of high MW isocyanate reactive compounds having a molecular weight >500 g/mol which can be selected from polyester diols, polyether diols and/or polyester polyether diols (including specialty polyester diols such as polycaprolactone or polycarbonate diols). In some embodiments, however, the amount of high MW polyols in the isocyanate reactive composition can be lower than 50 wt %, preferably lower than 40 wt %, preferably lower than 30 wt %, preferably lower than 20 wt %, preferably lower than 10 wt %, preferably lower than 5 wt %, more preferably lower than 2 wt % and most preferably lower than 1 wt % based on the total weight of all isocyanate reactive compounds in the reactive formulation.

According to some embodiments, the isocyanate reactive composition may optionally comprise a low amount of high MW isocyanate reactive compounds having a molecular weight >500 g/mol which are selected from polyester diols, polyether diols and/or polyester polyether diols (including specialty polyester diols such as polycaprolactone or polycarbonate diols) having a molecular weight in the range 500 g/mol up to 10000 g/mol, preferably in the range 500 g/mol up to 5000 g/mol, more preferably in the range 650 g/mol up to 4000 g/mol. In some embodiments, however, the amount of high MW polyols in the isocyanate reactive composition can be lower than 50 wt %, preferably lower than 40 wt %, preferably lower than 30 wt %, preferably lower than 20 wt %, preferably lower than 10wt %, preferably lower than 5 wt %, more preferably lower than 2 wt % and most preferably lower than 1 wt % based on the total weight of all isocyanate reactive compounds in the reactive formulation.

### The Isocyanate Composition

According to some embodiments, the isocyanate composition can have an NCO value in the range 3 up to 50, preferably in the range 5 up to 33.6, more preferably in the range 10 up to 33.6, more preferably in the range 15 up to 33.6, more preferably in the range 20 up to 33.6, more preferably in the range 25 up to 33.6, most preferably in the range 30 up to 33.6.

According to some embodiments, the isocyanate compounds in the isocyanate composition can be selected from aromatic isocyanate compounds, comprises at least 80% by weight, at least 85% by weight, at least 90% by weight, at least 95% by weight difunctional isocyanate compounds calculated on the total weight of all isocyanate compounds in the isocyanate composition. Most preferably the isocyanate composition can contain at least 80 wt %, at least 85 wt %, at least 90 wt %, at least 95 wt %, and most preferably at least 98 wt % 4,4′-diphenylmethane diisocyanates calculated on the total weight of the isocyanate composition.

According to some embodiments, the isocyanate composition used to make the TPU material can have a molecular number average isocyanate functionality in the range 1.8 up to 2.4, in the range of 1.8 up to 2.2, more preferably in the range of 1.9-2.1, more preferably in the range of 1.95-2.05, more preferably in the range of 1.95-2.02, more preferably in the range of 1.95-2.015, more preferably in the range of 1.95-2.012, even more preferably in the range of 1.98-2.01 and most preferably in the range of 1.98-2.005.

According to some embodiments, the difunctional isocyanates (diisocyanates) can be selected from aliphatic diisocyanates selected from hexamethylene diisocyanate, isophorone diisocyanate, methylene dicyclohexyl diisocyanate and cyclohexane diisocyanate and or from aromatic diisocyanates selected from toluene diisocyanate (TDI), naphthalene diisocyanate, tetramethylxylene diisocyanate, phenylene diisocyanate, toluidine diisocyanate and, in particular, diphenylmethane diisocyanate (MDI).

According to some embodiments, the isocyanate composition used in the processes disclosed herein can contain essentially (at least 95% by weight, more preferably at least 98% by weight calculated on the total weight of the polyisocyanate composition) pure 4,4′-diphenylmethane diisocyanate.

According to some embodiments, the isocyanate composition used in the processes disclosed herein can contain mixtures of 4,4′-diphenylmethane diisocyanate with one or more other organic diisocyanates, especially other diphenylmethane diisocyanates, for example the 2,4′-isomer optionally in conjunction with the 2,2′-isomer.

According to some embodiments, the isocyanate compounds in the polyisocyanate composition can also be an MDI variant derived from a isocyanate composition containing at least 95 wt % 4,4′-diphenylmethane diisocyanate. MDI variants are well known in the art and, for use in accordance with the present disclosure, particularly include liquid products obtained by introducing carbodiimide groups into said polyisocyanate composition and/or by reacting with one or more polyols.

According to some embodiments, the isocyanate compounds in the isocyanate composition can also be isocyanate-terminated prepolymer which can be prepared by reaction of an excessive amount of the isocyanate having at least 80 wt %, at least 85 wt %, at least 90 wt %, at least 95% of 4,4′-diphenylmethane diisocyanate with a suitable difunctional polyol in order to obtain a prepolymer having the indicated NCO value. Methods to prepare prepolymers have been described in the art. The relative amounts of isocyanate and polyol depend on their equivalent weights and on the desired NCO value and can be determined easily by those skilled in the art. The NCO value of the isocyanate-terminated prepolymer can be preferably above 3%, preferably above 5%, more preferably above 8% and most preferably above 10%.

Further Additives and/or Fillers

According to some embodiments, the reactive formulation can further comprise fillers such as wood chips, wood dust, wood flakes, wooden plates; paper and cardboard, both shredded or layered; sand, vermiculite, clay, cement and other silicates; ground rubber, ground thermoplastics, ground thermoset materials; honeycombs of any material, like cardboard, aluminium, wood and plastics; metal particles and plates; cork in particulate form or in layers; natural fibers, like flax, hemp and sisal fibers; synthetic fibers, like polyamide, polyolefin, polyaramide, polyester and carbon fibers; mineral fibers, like glass fibers and rock wool fibers; mineral fillers like BaSO₄ and CaCO₃; nanoparticles, like clays, inorganic oxides and carbons; glass beads, ground glass, hollow glass beads; expanded or expandable beads; untreated or treated waste, like milled, chopped, crushed or ground waste and in particular fly ash; woven and non-woven textiles; and combinations of two or more of these materials.

According to some embodiments, the amount of additives and/or fillers used in the TPU materials disclosed herein can be in the range of 0-95 w % based on the total weight of the final (filled/compounded) material.

According to some embodiments. the amount of additives and/or fillers used in the TPU materials disclosed herein can be in the range of 10-60 w % based on the total weight of the final (filled/compounded) material. More preferably the amount of additives and/or fillers can be in the range of 20-50 w % or even 30-40 w %. In some cases the most preferred fillers can be fibers or strand-like materials.

According to some embodiments, the amount of additives and/or fillers used in the TPU materials disclosed herein can be in the range of 40-95 w % based on the total weight of the final (filled/compounded) material. More preferably the amount of additives and/or fillers can be in the range of 50-80 w % or even 60-75 w %. In some cases the most preferred fillers can be powders, spheres, or fine particles.

According to some embodiments, the amount of additives and/or fillers used in the TPU materials disclosed herein can be >40 w % based on the total weight of the final (filled/compounded) material, more preferably >50 w %, more preferably >60 w %, most preferably >70 w %.

According to some embodiments, a high amount of additives and/or fillers can be used/incorporated in the TPU materials due to the lower melt viscosity of the amorphous TPU materials. This higher additive and/or filler level can achieve superior performance over similar materials with a lower filler level. In some cases, the preferred fillers to be used in high quantity are fibers, powders, spheres or fine particles.

According to some embodiments, the reactive formulation can further comprise solid polymer particles such as styrene-based polymer particles. Examples of styrene polymer particles include so-called “SAN” particles of styrene-acrylonitrile. Alternatively, small amounts of polymer polyols may be added as an additional polyol in the isocyanate reactive composition. An example of a commercially available polymer polyol is HYPERLITE® Polyol 1639 which is a Polyether polyol modified with a styrene-acrylonitrile polymer (SAN) with a solid content of approximately 41 wt % (also referred to as polymer polyol).

According to some embodiments, other conventional ingredients (additives and/or auxiliaries) may be used in making the TPU materials. These include surfactants, flame proofing agents, fillers, pigments, stabilizers, blowing agents (including physical and chemical blowing agents), antioxidants, plasticizers, colors, processing additives (such as waxes), and the like.

According to some embodiments, other polymers may be combined with the TPU materials, including, but not limited to, low and high density polyethylene, polypropylene, polystyrene, polytetrafluoroethylene, polyvinylchloride, polychlorotrifluoroethylene, polyamide, polyaramide, polyphenolformaldehyde, polyethyleneterephthalate, polyacrylonitrile, polyimide, aromatic polyesters and the like; and combinations of two or more of these polymers together with the TPU material.

According to some embodiments, suitable catalysts can accelerate in particular the reaction between the NCO groups of the diisocyanates a) and accelerate the hydroxyl groups of the isoreactive compounds and can be selected from those known in the prior art such as metal salt catalysts (such as organotins, organobismuth, organozinc and the like), and amine compounds, such as triethylenediamine (TEDA), N-methylimidazole, 1,2-dimethylimidazole, N-methylmorpholine, N-ethylmorpholine, triethylamine, N,N′-dimethylpiperazine, 1,3,5-tris(dimethylaminopropyl) hexahydrotriazine, 2,4,6-tris(dimethylaminomethyl)phenol, N-methyldicyclohexylamine, pentamethyldipropylene triamine, N-methyl-N′-(2-dimethylamino)-ethyl-piperazine, tributylamine, pentamethyldiethylenetriamine, hexamethyltriethylenetetramine, heptamethyltetraethylenepentamine, dimethylaminocyclohexylamine, pentamethyldipropylene triamine, triethanolamine, dimethylethanolamine, bis(dimethylaminoethyl)ether, tris(3-dimethylamino)propylamine, or its acid blocked derivatives, and the like, as well as any mixture thereof. The catalyst compounds can be present in the reactive composition in a catalytically effective amount, generally from about 0 to 5% by weight, preferably 0 to 2-% by weight, most preferably 0 to 1-% by weight, based on total weight of all reactive ingredients used.

### The Method for Making the TPU Material

All reactants in the reactive formulation can be reacted at once or can be reacted in a sequential manner. By prior mixing all or part of the isocyanate-reactive compounds, solutions or suspensions or dispersions can be obtained. The various components used in the manufacture of the compositions can be added in any order. The process can be selected from a bulk process, either batch or continuous process, including a casting process, and reactive extrusion process.

As an example, the process for making the TPU materials can comprise at least the steps of:
i. pre-mixing the isocyanate reactive compounds, the catalyst compounds and further additives and/or fillers, and then
ii. mixing the isocyanate composition with the composition obtained in step i) to form a reactive formulation, and
iii. allowing the reactive formulation obtained in step ii) to react, and then
iv. optionally curing and/or annealing the TPU material obtained in step iii) at an elevated temperature.

According to some embodiments, the step of mixing of the polyisocyanate composition with the pre-mixed composition obtained in step i) to form a reactive formulation can be performed using a 2-component mixing system. According to some embodiments, the mixing system can be a pressure mixing system. According to embodiments, the pressure mixing system can be a high pressure mixing system that uses impingement to mix materials.

According to some embodiments, the step of mixing of the polyisocyanate composition with the pre-mixed composition obtained in step i) to form a reactive formulation is performed using a 2-component dynamic mixing system.

According to some embodiments, the step of mixing of the polyisocyanate composition with the pre-mixed composition obtained in step i) to form a reactive formulation can be performed using a combination of impingement and dynamic mixing.

According to some embodiments, the process for making the TPU materials can use a Castech® casting process, a batch process, and/or a reactive extrusion.

According to some embodiments, no external heat is preferably added to the reactive formulation, the reaction exotherm is sufficient to obtain the final structure.

According to some embodiments, the step of allowing the reactive formulation obtained in step ii) to react can be performed in a mould and the mould temperature can be altered to affect skin properties. Elevated mould temperature can also prevent excessive heat loss, hereby helping conversion/molecular weight build-up during polymerization.

According to some embodiments, the method for making the TPU materials can be performed at an isocyanate index in the range 75 up to 125, in the range 80 up to 120, in the range 85 up to 120, in the range 88 up to 120, in the range 90 up to 120, in the range 90 up to 110, in the range 92 up to 110, in the range 95 up to 110, in the range 95 up to 105, in the range 95 up to 102, or in the range 95 up to 100.

### The TPU Material

According to some embodiments, the TPU materials used in the core of the flooring panels can have a Tg>25° C., preferably a Tg>35° C. preferably a Tg>40° C., more preferably a Tg>45° C., more preferably a Tg>50° C., more preferably a Tg>55° C., most preferably a Tg>70° C.

According to some embodiments, the TPU materials used in the core of the flooring panels can have an apparent density (ISO 1183-1) in the range 300-10000 kg/m³, in the range 500-5000 kg/m³, in the range 500-2500 kg/m³, in the range 750-2500 kg/m³, in the range 900-2500 kg/m³, in the range 900-2000 kg/m³, in the range 900-1500 kg/m³, in the range 900-1300 kg/m³, in the range 1000-1300 kg/m³, in the range 1100-1300 kg/m³, measured according to ISO 1183-1.

According to some embodiments, the TPU materials used in the core of the flooring panels can have an apparent Shore D hardness (measured according to DIN ISO 7619-2) in the range of 50 up to 100, more preferably in the range 60 up to 100, more preferably in the range 70 up to 100, more preferably in the range 70 up to 90, most preferably in the range 75 up to 85.

According to some embodiments, the TPU materials used in the core of the flooring panels can have an elongation (according to DIN 53504) in the range of 1 up to 500%, more preferably in the range of 1 up to 400%, more preferably in the range of 1 up to 300%, more preferably in the range of 1 up to 200%, more preferably in the range of 1 up to 100%, more preferably in the range of 1 up to 50%, most preferably in the range of 1 up to 30%.

According to some embodiments, the TPU materials used in the core of the flooring panels can have a flexural modulus (according to ISO 178) in the range of 300 up to 15000 MPa, more preferably in the range of 500 up to 12000 MPa, more preferably in the range of 800 up to 10000 MPa, more preferably in the range of 800 up to 6000 MPa, more preferably in the range of 800 up to 5000 MPa, more preferably in the range of 1200 up to 3500 MPa, most preferably in the range of 1500 up to 2700 MPa.

According to some embodiments, the TPU materials used in the core of the flooring panels can have a tensile strength at break (according to DIN 53504) in the range of 5 up to 150 MPa, more preferably in the range of 15 up to 120 MPa, more preferably in the range of 30 up to 100 MPa, more preferably in the range of 40 up to 90 MPa, most preferably in the range of 50 up to 80 MPa.

According to some embodiments, the TPU materials used in the core of the flooring panels can have a tensile strength at maximum load (according to DIN 53504) in the range of 5 up to 150 MPa, more preferably in the range of 15 up to 120 MPa, more preferably in the range of 30 up to 100 MPa, more preferably in the range of 40 up to 90 MPa, most preferably in the range of 50 up to 80 MPa.

According to some embodiments, the TPU materials used in the core of the flooring panels can be made using a reactive formulation wherein the aromatic dicarboxylic acid based diol chain extender is a terephthalic acid based polyester diol chain extender made from recycled PET and said TPU material can contain a recycled content of ≥2 w %, more preferably of ≥5 w %, more preferably of ≥10 w %, more preferably of ≥15 w %, more preferably of ≥20 w %, most preferably of ≥25 w % based on the total weight of the TPU material (excluding any fillers). When fillers are included in the calculation of the recycled content of the TPU material, said TPU material is containing a recycled content of ≥1 w %, more preferably of ≥2 w %, more preferably of ≥3 w %, more preferably of ≥4 w %, most preferably of ≥5 w %.

The TPU materials disclosed herein can have thermoplastic properties. Accordingly, the disclosure provides a process for recycling and/or remelting the thermoplastic polyurethane cores of the flooring panels into new applications without significantly deteriorating the thermoplastic polymer matrix compared to state of the art high flexural modulus and high hardness materials, such a high hard-block TPU's (with a low degradation temperature) or thermoset material. Compared to these materials, the TPU materials disclosed herein can be more easily recycled and/or remelted.

According to some embodiments, the remelting/recycling of the thermoplastic TPU cores of the flooring panels can be performed by a heat and/or compression processes at temperatures above the melting temperature of the thermoplastic materials.

According to some embodiments, the remelting/recycling of the thermoplastic TPU cores of the flooring panels can be performed by processes at temperatures above the melting temperature of the thermoplastic material to recover and/or separate the TPU from any of the used fillers or fibers.

According to some embodiments, the recycling of the thermoplastic TPU cores of the flooring panels can be performed by a process using a solvent or a combination of solvents.

According to some embodiments, the remelting/recycling of the thermoplastic TPU cores of the flooring panels can be performed by processes using a solvent or a combination of solvents to recover and/or separate the TPU from any of the used fillers or fibers.

According to some embodiments, the remelting/recycling of the thermoplastic cores of the flooring panels can be performed in an extruder at temperatures above the melting temperature of the thermoplastic material. By further addition of a blowing agent in the extruder a foamed recycled TPU foam might be achieved.

According to some embodiments, the TPU materials can be processed at a temperature below 250° C., preferably at a temperature<245° C., preferably at a temperature<240° C., preferably at a temperature<235° C., preferably at a temperature<230° C., preferably at a temperature<225° C., preferably at a temperature<220° C., preferably at a temperature <215° C., preferably at a temperature<210° C., preferably at a temperature<205° C., preferably at a temperature<200° C., preferably at a temperature<195° C., preferably at a temperature<190° C., preferably at a temperature<185° C., most preferably at a temperature<180° C.

According to some embodiments, the TPU materials can be processed by all customary methods used in the processing of thermoplastics, for example by injection moulding, extrusion, calendaring, thermoforming, roll milling, rotational moulding, sintering methods or from solution (using a suitable solvent). Processing methods without the use of solvents are most preferred.

The disclosure further provides a thermally reformed material based on the thermoplastic cores of the flooring panels. In some cases, it is preferred to use the thermally reformed/recycled thermoplastic material in an identical application field as the original application, e.g., flooring panels.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

1. A flooring panel, comprising:
a core layer comprising a thermoplastic polyurethane (TPU) having a shore D hardness (measured according to DIN ISO 7619-2) in a range 50-100 and a glass transition temperature (Tg, measured according to ISO 11357-2:2020) above room temperature, said TPU formed from a reactive formulation, comprising:
an isocyanate composition comprising at least one difunctional isocyanate compound;
an isocyanate-reactive composition comprising isocyanate-reactive compounds selected from at least one aromatic dicarboxylic acid based diol chain extender having a molecular weight <500 g/mol;
optionally a catalyst compound; and
optionally additives and/or fillers,
wherein a hardblock content of the reactive formulation is >70 wt % based on a total weight of the isocyanate and isocyanate-reactive composition, an isocyanate index is in the range 75 up to 125, and a number average isocyanate functionality and/or a number average hydroxy functionality is in the range of 1.8 up to 2.5;
optionally a top layer above a top surface of the core; and
optionally a bottom layer below a bottom side of the core.

2. The flooring panel according to claim 1, wherein the isocyanate-reactive composition has an hydroxy functionality in the range 1.8 up to 2.4, and comprising at least 10 wt % of aromatic carboxylic acid based diol chain extenders having a molecular weight <500 g/mol calculated on the total weight of all chain extenders in the isocyanate reactive composition.

3. The flooring panel according to claim 1 wherein the TPU has a Tg (measured according to ISO 11357-2:2020) >35° C.

4. The flooring panel according to claim 1, wherein the isocyanate reactive composition comprises aromatic and aliphatic based diols such that at least 20 wt % of the diols are selected from aromatic dicarboxylic acid based diols based on the total weight of the isocyanate reactive composition.

5. The flooring panel according to claim 1 wherein said aromatic dicarboxylic acid based diol chain extender is based on phthalic acid selected from o-phthalic acid, m-phthalic acid, and p-phthalic acid).

6. The flooring panel according to claim 5, wherein the aromatic dicarboxylic acid based diol chain extender is a terephthalic acid based polyester diol chain extender made from recycled PET.

7. The flooring panel according to claim 1, wherein the hardblock content of the reactive formulation is >70 wt %.

8. The flooring panel according to claim 1, wherein the number average functionality of isocyanate reactive compounds and/or isocyanate compounds and/or the complete reactive formulation (including all isocyanate and isocyanate reactive compounds) is in the range of 1.8 up to 2.5.

9. The flooring panel according to claim 1, wherein the isocyanate composition has an NCO value in the range 3 up to 50.

10. The flooring panel according to claim 1, wherein the isocyanate compounds in the isocyanate composition are selected from aromatic isocyanate compounds, and wherein the isocyanate composition contains at least 80 wt %, 4,4′-diphenylmethane diisocyanates calculated on the total weight of the isocyanate composition.

11. The flooring panel according to claim 1, wherein the isocyanate index of the reactive foam formulation is in the range 75 up to 125.

12. The flooring panel according to claim 1, wherein the aromatic dicarboxylic acid based diol chain extender have a molecular weight in the range 45 g/mol up to 500 g/mol.

13. A process for making a flooring panel, the panel having a core comprising a thermally recyclable TPU, the process comprising:
combining and reacting the compounds of the reactive formulation according to claim 1 to form the TPU, and
forming the TPU into the core.

14. The process according to claim 13, wherein forming the TPU into the core comprising extruding the TPU.

15. The process according to claim 13, further comprising attaching an underlayment pad to a bottom side of the core.

16. The process according to claim 15, wherein the underlayment comprises a TPU.

17. The process according to claim 13, further comprising providing a protective layer above a top surface of the core.

18. The process according to claim 17, wherein the protective layer comprises a TPU.

19. The process according to claim 13, further comprising providing a decorative print layer to a top surface of the core.

20. The process according to claim 13, further comprising printing a decorative pattern on a top surface of the core.

21. A flooring panel having a core, the core comprising a thermoplastic polyurethane (TPU) material having a glass transition temperature (Tg)>room temperature, a flexural modulus in the range 300-15000 MPa (measured according to ISO 178), and a tensile strength at break (according to DIN 53504) in the range of 5 up to 150 MPa, the TPU material made by combining and reacting the compounds of the reactive formulation according to claim 1.

22. The flooring panel according to claim 21 made using a reactive formulation wherein the aromatic dicarboxylic acid based diol chain extender is a terephthalic acid based polyester diol chain extender made from recycled PET and said TPU material contains a recycled content of ≥2 w % based on the total weight of the TPU material (excluding any fillers).
